(19) United States
(12) Patent Application Publication
(10) Pub. No.: US 2014/0359042 A1
(43) Pub. Date: Dec. 4, 2014

(54) Programmable Automation with the Aid of a Social Network

(71) Applicants: Jeffrey G. Fenley, Simi Valley, CA (US); Vasiliy V. Bogatov, St. Petersburg (RU)

(72) Inventors: Jeffrey G. Fenley, Simi Valley, CA (US); Vasiliy V. Bogatov, St. Petersburg (RU)

(21) Appl. No.: 14/267,549

(22) Filed: May 1, 2014

Related U.S. Application Data
(60) Provisional application No. 61/829,547, filed on May 31, 2013.

(51) Int. Cl. H04L 12/24

(52) U.S. Cl. CPC H04L 41/046
USPC 709/208

(57) ABSTRACT

The present disclosure provides methods for communicating with at least one peripheral device of a user, comprising providing a computer server that is in communication with an automation controller that is operatively coupled to at least one peripheral device of the user. The computer server hosts a social network that comprises an automation application that is programmed to permit the user to access the peripheral device. Next, at the computer server through the automation controller, information is received from the peripheral device that is of or related to a state of the peripheral device. Based on the information received computer server, the user or another user selected by the user is provided an indication as to the state of the peripheral device. The indication is provided to the user or the other user through the automation application on the social network.

### CROSS-REFERENCE

This application claims priority to U.S. Provisional Patent Application Ser. No. 61/829,547, filed May 31, 2013, which is entirely incorporated herein by reference.

### BACKGROUND

Currently, residential and industrial automation systems are complex and sophisticated. They can consist of hardware from different manufacturers, including multiple subsystems for achieving specific automation functions, different user interaction interfaces for controlling and monitoring the automation environment, and different interaction interfaces and protocols for communication amongst various devices and subsystems. Often, automation systems are made up of specific individual purpose-oriented subsystems that do not interact with each other, but instead that each individually interacts directly with the user in a different manner. For example, an indoor climate control system, and electronic door locks both have their own ultimate purposes and each system interacts with the user in a different manner. As an example, a user might login directly to their climate control system from a remote location on the Internet to control and monitor climate functions in their structure. The system may alert the user via some electronic messaging system if there is an event that needs attention. Electronic door locks may respond to a proximity signal from your smart phone or a secret combination on the keyboard of the door. Comprehensive home and industrial automation systems that contain a multitude of components, from different manufacturers, designed to accomplish multiple and specific automation tasks, and that operate on multiple protocols, are heterogeneous from a user interaction and user interface point of view. In order to enjoy full access to all of the functionality of an automation environment, a user typically accesses various system functions through multiple systems and/or user interfaces. Moreover, different subsystems of one automation system may have physical distance limitations placed on user interaction. For instance, in the case of electronic door locks controlled by Bluetooth®, or Near Field Communication (NFC), the user must be in close physical proximity to the locks in order to operate them. In the case of the climate control system, you can control the environment remotely and get alarm messages by short message service (SMS) text or electronic mail (email). Electronic door locks are an example of direct interaction; the climate control system is an example of remote interaction.

Furthermore, when various heterogeneous subsystems exist within an automation environment, each subsystem is unable to realize additional functional potential beyond its defined purpose due to the fact that many of these various subsystems cannot communicate with each other. Take together the examples of electronic door locks and a climate control system. Each system is heterogeneous and they do not communicate with each other. By allowing logical operations (software routines) to occur in relation to various natively non-compatible subsystem components, additionally functionality can be realized that is much more complex and is far superior to the functionality of individual subsystem components that do not interact. But present systems and concept of automation do not allow systems to achieve such logical operations.

As a result of multiple hardware devices, multiple protocols, and a high degree of non-interoperability between devices from different manufacturers, the user is left with multiple automation systems that are heterogeneous; different automation functions are controllable via different user interfaces and by different methods (e.g., login remotely from a browser, send commands by Bluetooth, create a proprietary algorithm and download it into an appliance, etc.). The physical distance limitations on user interaction with an automation system and an automation system's ability to provide the user with alerts can depend on the functionality of the specific automation system, machine, or appliance.

Today's automation systems may give users the ability to control specific devices, perform specific functions, receive alerts and notifications based on circumstances or events, and to monitor critical states and parameters of the automation system, among other things. As described previously, a climate control automation system may alert a user by email, SMS, and so on. Alert types depend on the automation system manufacturer and the type of system. Some alerts could be available for a user remotely (e.g., SMS, email), and some only within a close physical distance (e.g., sound from a fire alarm). If a complex automation system consists of several heterogeneous subsystems (e.g., fire control system, security system, climate control system, etc.), alerting methods for such an automation system become too confusing, complex, and cumbersome to manage effectively. From a user's point of view, all of these subsystems should look like one seamless automation system, managing all of the useful physical and virtual processes that are available in the automation environment from a single unified user interface. Complex automation systems are heterogeneous, often do not allow communication between various subsystems, and do not offer unified access and alerting methods.

Some purpose-oriented automation systems can generate an alert in the case of some pre-defined circumstance(s). For example, a security system sounds an alarm if somebody penetrates into a home without appropriate authorization. In addition, fire or smoke detection systems sound an alarm if fire or smoke is detected. As said above, the distance and method of alerting the user to an alarm depends on the system installed. The goals of such an alarm system are to prevent loss of, or damage to, property. Some systems remotely contact and alert a trusted service or person to check on the cause of an alarm. This is an example of delegation of some responsibility for controllable processes by an automation system. The main goal of such delegation is the prevention of property loss or damage. Usually, alarm subsystems are installed, serviced and programmed by the same organization or company. Normally, a user does not have the ability to quickly and easily re-delegate responsibility for some controllable processes to another company. If a user wants to re-delegate responsibility to a third party, they need to contact their service provider, or install another subsystem, both of which can be costly and unnecessary expenses. In other words, something as simple as re-delegation of a task could be a reason for spending time, money and sometimes reconstruction of the system for the user. With current systems, a user has limited choices for managing delegation of tasks.

The main goal of any automation system is to manage some useful physical or virtual process, or processes. Installation of automation systems and appliances to manage these processes requires specific knowledge. The requisite knowledge depends on the manageable processes and the specifics of a given automation system and its appliances. An installation procedure could vary from simple to extremely complex. Additionally, manufacturers of automation systems offer a variety of computer-based utilities (e.g., CAD for graphical entering of algorithms) to assist with an installation. Such computer utilities also require extra knowledge and sometimes extra-tools for implementation (e.g., software programs and hardware programmers for a programmable logic controller (PLC)).

As a result of these generally complex installation requirements, a user needs to expend extra effort for the installation of an automation system (e.g., time consumption, specific knowledge, engagement of an installation service, money, tools, etc.).

The extremely large variety of processes manageable by automation systems, and the methods of interaction between various heterogeneous systems, appliances, and end-users, adds to the complexity of monitoring such systems for the user. The methods of an automation system's representation of states vary too. In order to upgrade, expand, or change the functionality of a system, you need specific knowledge and extra effort (e.g., time consumption, specific knowledge, engagement of an installation service, money, tools, etc.).

However, present suppliers of complex automation solutions with unified user interfaces do not provide the user with a method to delegate and/or re-delegate tasks such as alerts to trusted services, people, or other machines.

### SUMMARY

The present disclosure provides devices, systems and methods that may be used or applied in various settings, such as installation, operation, interoperability, monitoring, and upgrade settings.

Devices of the present disclosure can enable use of remote devices and systems by way of a social network. This can enable a user to automate the use of remote devices and/or systems using a social network (e.g., Facebook®, Google+®, Twitter®, LinkedIn®, VK.COM, or Tumblr®). In some examples, the user access the social network through an account of the user and uses an application (“app”) installed on or associated with the social network account of the user to regulate, control or access a remote device or system (e.g., heater, cooler, thermostat, television, camera, etc.).

Systems of the present disclosure can enable (i) an installation and upgrade methodology for different subsystems of a complex automation system, (ii) the unification of different methodologies for user interaction with subsystems of a complex automation system, and (iii) accessing multiple devices and/or systems through a common interface regardless of methodology and distance restrictions. Devices and systems of the present disclosure can provide user alerts when a given (e.g., user-defined condition) is met, and can enable a user to delegate and re-delegate responsibility for different alert signals to third parties according to the user's preferences. Systems of the present disclosure can be part of a network of compatible automation subsystems that are capable of communicating with each other, such as to distribute workload or allocate resources. Systems and device of the present disclosure may be scalable without the installation of extra hardware. This can advantageously enable a user to have unified control and a unified distance of interaction with various remote devices, systems or sub-systems in a homogenous fashion, each of which, on their own, may be otherwise heterogeneous from a user-interaction point of view.

The present disclosure provides devices, systems and methods that are capable of unifying and automating the deployment, upgradability, customization, interaction, monitoring, data collection, etc. of an automation system, to allow new and additional functionality to be realized within the automation environment by facilitating communication between various incompatible subsystems and allowing for user-programmable logical operations to occur based on states of various subsystems of the automation system, to allow unified access to an automation system through a secure connection to a user's social network account, and to make those actions independent of processes controllable by the automation system, skill level of the user and distance between the user and the automation system.

An aspect of the present disclosure provides a device that is controllable via a social network, which switches electrical power on a plurality of executive mechanisms, to provide a user with a means for automating some useful physical process, and to control and monitor the process through a social network account. To provide the user with a unified method of installing and upgrading functionality of the device independent of the process and distance to it, the device comprises: at least one output port as an integral part to switch electrical power on a mechanism connected to it; at least one input port to communicate with one or more sensors operatively coupled to the input port; a controller module that stores and executes programs using one or more computer processors, and determines states of the output port and gathers information from the input port; a network communication module that is in communication with a social network; an application (“app”) based on the social network for communication with and installing programs, monitoring the controller module, and communicating with a user; a drivers database located in the social network which includes drivers downloadable to the controller module for communicating with the one or more sensors connected to the input port; a usage case database located in the social network and containing the program to execute on the controller module; and a user account module for communicating with the application.

The foregoing device may be an integral part of an electrical appliance. The controller module can execute the program in accordance with requirements for the electrical appliance and the case of usage. A user can install the controller to automate a plurality of physical processes in unified form independent of the nature of the physical processes, control and monitor the physical processes in the unified manner independent of distance between user and the process, and share information of the physical processes with a third party via the social network or other communications interface.

Devices and systems of the present disclosure provide various non-limiting benefits, such as, for example, (i) a unified method of installation and upgrading, independent of the specific case of usage of a deployed automation system and independent of the physical distance from the system to the user; (ii) a unified method of interaction, independent of case of usage, with a deployed automation system and independent of the physical distance from the system to the user; (iii) a unified method and distance for allowing user interaction with the automation system and delivery of alerts to the user by the automation system; (iv) one unified tool and method to program functionality, delegate, re-delegate and tune an automation system, independent of case of usage of an automation system; (v) a unified method of alerts delegation to a trusted service or person, independent of case of usage of an automation system; (vi) a device embodied as a programmable automation controller, controllable through a social network account, as a hardware platform to manage and unify access to all possible automation processes of heterogeneous subsystems in an automation environment; (vii) a method for allowing heterogeneous subsystems to interact with each other and realize additional and previously unattainable functions and results; (viii) a device for allowing heterogeneous subsystems to interact with each other and realize additional and previously unattainable functions and results; and (ix) an application based on a social network to communicate with, control, monitor, etc. the programmable automation controller.

Devices, systems and methods of the present disclosure can be used to control or regulate such peripheral devices, such as monitor a status of such peripheral devices, receive information from such peripheral devices, or regulate power to such peripheral devices (e.g., turn a peripheral device on or off). This can enable a user to regulate, monitor or access an environment associated with the user remotely, which advantageously precludes the need for the user to be physically present in the environment. The user can regulate, monitor or access a peripheral device in the environment of the user in a matter of seconds, if not substantially instantly, using a social network of the user, which enables the user to centralize the day-to-day activities of the user, including maintaining communication with friends. In some situations, the user can use a portable or mobile device to regulate, monitor or access the environment through a social network of the user, which can be provided by a computer server that is programmed or otherwise configured to provide such social network.

An aspect of the present disclosure provides a method for accessing at least one peripheral device of a user, comprising (a) using a user interface on an electronic device of a user, accessing an automation application in a social network hosted by at least one computer server, wherein the computer server is in communication with an automation controller that is operatively coupled to at least one peripheral device of the user, and wherein the peripheral device is accessible by the automation application through the automation controller; (b) receiving, by the automation application accessed through the user interface, at least one user instruction from the user to access the peripheral device; (c) using the computer server, directing the automation controller to access the peripheral device based on the user instruction; and (d) accessing the peripheral device based on the user instruction. In an embodiment, the instruction is to receive information from the peripheral device, and wherein the information is received from the peripheral device and presented to the user in the automation application. In another embodiment, the information is of or related to a state of the peripheral device. In another embodiment, the instruction is to control or monitor the peripheral device. In another embodiment, the at least one peripheral device comprises a plurality of peripheral devices. In another embodiment, at least a subset of the plurality of peripheral devices includes different devices. In another embodiment, the method further comprises, prior to (a), bringing the automation controller in communication with the computer server. In another embodiment, the method further comprises providing, from the automation application, one or more drivers to enable the automation application to communicate with the peripheral device. In another embodiment, the peripheral device is an appliance, a monitoring system, a sensor, or an entertainment system. In another embodiment, the method further comprises, subsequent to (d), directing an alert to the user using the social network. In another embodiment, the method further comprises, subsequent to (d), directing an alert to another user selected by the user.

Another aspect of the present disclosure provides a method for communicating with at least one peripheral device of a user, comprising (a) providing a computer server that is in communication with an automation controller that is operatively coupled to at least one peripheral device of the user, wherein the computer server hosts a social network that comprises an automation application that is programmed to permit the user to access the peripheral device; (b) receiving, at the computer server through the automation controller, information from the peripheral device that is of or related to a state of the peripheral device or an environment in proximity to the peripheral device; and (c) based on the information received at the computer server, providing the user or another user selected by the user an indication as to the state, which indication is provided to the user or the another user through the automation application on the social network. In an embodiment, the access comprises receiving information from or providing instructions to the peripheral device. In another embodiment, the at least one peripheral device comprises a plurality of peripheral devices. In another embodiment, the plurality of peripheral devices comprises a sensor and a non-sensor peripheral device. In another embodiment, the method further comprises, prior to (a), bringing the automation controller in communication with the computer server. In another embodiment, the method further comprises providing, from the automation application, one or more drivers to enable the automation application to communicate with the peripheral device. In another embodiment, the indication is provided in the social network. In another embodiment, the indication is provided on a newsfeed or other data feed of the social network. In another embodiment, the indication is provided in a third party application that is external to the social network. In another embodiment, the peripheral device is an appliance, a monitoring system, a sensor, or an entertainment system. In another embodiment, indication is an alert.

Another aspect of the present disclosure provides a system for communicating with at least one peripheral device of a user, comprising (a) a port that is in communication with the peripheral device; (b) a network communication module that is in communication with a social network that is hosted by a computer server, wherein the social network comprises an automation application that enables a user to (i) provide one or more instructions to control or regulate the peripheral device, or (ii) receive at least one indication as to a state of the peripheral device; and (c) a computer processor that is operatively coupled to the port and the network communication module, wherein the computer processor is programmed to (i) receive the one or more instructions from the automation application of the social network through the network communication module, or (ii) receive information from the peripheral device through the port and direct the at least one indication to the social network through the network communication module. In an embodiment, the access comprises receiving information from or providing instructions to the peripheral device. In another embodiment, the at least one peripheral device comprises a plurality of peripheral devices. In another embodiment, at least a subset of the plurality of peripheral devices includes different devices. In another embodiment, the peripheral device is an appliance, a monitoring system, a sensor, or an entertainment system. In another embodiment, the indication is an alert. In another embodiment, the one or more instructions are provided by the user through the automation application. In another embodiment,

Another aspect of the present disclosure provides a computer readable medium comprising machine-executable code that, upon execution by one or more computer processors implements a method for communicating with at least one peripheral device of a user, the method comprising (a) providing a computer server that is in communication with an automation controller that is operatively coupled to at least one peripheral device of the user, wherein the computer server hosts a social network that comprises an automation application that is programmed to permit the user to access the peripheral device; (b) receiving, at the computer server through the automation controller, information from the peripheral device that is of or related to a state of the peripheral device; and (c) based on the information received computer server, providing the user or another user selected by the user an indication as to the state of the peripheral device, which indication is provided to the user or the another user through the automation application on the social network.

Another aspect of the present disclosure provides a computer readable medium comprising machine executable code that, upon execution by one or more computer processors, implements any of the methods above or elsewhere herein.

Another aspect of the present disclosure provides a control system comprising one or more computer processors and memory coupled thereto. The memory can comprise machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “FIG.” and “FIGs.” herein), of which:

FIG. 1 schematically illustrates a block diagram of a method of user interaction with an automation controller controllable through a social network;

FIG. 2 schematically illustrates a system comprising social-network-based components, which permit a user to control and monitor the programmable automation controller;

FIG. 3 shows a block diagram of a social-network-based application interacting with a programmable automation controller;

FIG. 4 is a block diagram of hardware components of a programmable automation controller controllable through a social network;

FIG. 5 is a block diagram of an automation controller controllable through a social network as part of an appliance;

FIG. 6 is a computer system that is programmed or otherwise configured to implements various methods and systems of the present disclosure; and

FIG. 7 schematically illustrates an example of a programmable automation controller of the present disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “social network,” as used herein, generally refers to a social structure that comprises a set of social users (such as individuals or organizations) and a set of the dyadic ties between these users. A social network can be captured electronically, such as by way of a system that determines and maintains ties between users of the social network. A social network can be provided by a social media provider (e.g., Facebook®, Google+®, or VK.COM).

The term “driver,” as used herein, generally refers to a program (or other computer executable instructions) that operates, controls or otherwise enables communication with a particular type of device that is operatively coupled to another device.

The term “state,” as used herein, generally refers to a condition of a device, a condition of a mode of operation of the device, or a condition in an environment in proximity to the device. In an example, the state of a washing machine can be either on or off.

### Methods and Systems for Accessing Peripheral Devices Using a Social Network

An aspect of the present disclosure provides a method for accessing or receiving information from a peripheral device of a user, comprising accessing an automation application in a social network hosted by at least one computer server using a user interface on an electronic device of a user. The computer server can be in communication with an automation controller that is operatively coupled to at least one peripheral device of the user. The peripheral device can be accessible by the automation application through the automation controller. Next, at least one user instruction is received from the user to access or receive information from the peripheral device. The instruction can be received by the automation application that is accessed through the user interface. Next, using the computer server, the automation controller is directed to access or receive information from the peripheral device based on the user instruction. Next, the peripheral device is accessed based on the user instruction. As an alternative, or in addition to, information can be received from the peripheral device.

The electronic device can be a geolocation device, which can determine and provide the geolocation of the electronic device. The geolocation of the electronic device can be used to determine or approximate the geolocation of the user. The geolocation of the electronic device can be determined by various approaches, such as, for example, triangulation.

In some examples, the instruction is to receive information from the peripheral device. In such a case, the information can be received from the peripheral device and presented to the user in the automation application. The information can be of or related to a state (e.g., on, off, or inoperable) of the peripheral device.

In some cases, the instruction is to access the peripheral device. Such access can comprise controlling the peripheral device. For example, the instruction can be to turn an oven on or off.

The at least one peripheral device can comprise at least 1, 2, 3, 4, 5, 6, 7, 8, 9, 10, 20, 30, 40, 50, 100, or more peripheral devices. In some cases, at least a subset of a plurality of peripheral devices includes different devices. For example, a first device can be an oven and a second device can be a heater. In some cases, the plurality of peripheral devices includes sensor peripheral devices (or sensors) and non-sensor peripheral devices (i.e., peripheral devices other than sensors).

In some cases, the method further comprises bringing the automation controller in communication with the computer server. This can include providing from the automation application one or more drivers to enable the automation application to communicate with the peripheral device.

Various types of peripheral devices can be used. In some examples, the peripheral device is an appliance, monitoring system, sensor or an entertainment system.

Another aspect of the present disclosure provides a method for communicating with at least one peripheral device of a user, comprising providing a computer server that is in communication with an automation controller that is operatively coupled to at least one peripheral device of the user. The computer server hosts a social network that comprises an automation application that is programmed to permit the user to access the peripheral device. Next, information is received from the peripheral device at the computer server through the automation controller. The information can be related to a state of the peripheral device or an environment in proximity to the peripheral device. Based on the information, the user or another user selected by the user is provided an indication as to the state of the peripheral device or the environment. The indication can be provided to the user or the other user through the automation application on the social network. For example, the indication can be provided on the automation application that is in use on a user interface (UI) of an electronic device of the user.

In some cases, the access comprises receiving information from or providing instructions to the peripheral device. For example, the user can access the peripheral device by receiving information indirectly from the peripheral device (e.g., through the automation controller) or by providing indirectly providing instructions to the peripheral device, such as through the automation controller. In some embodiments, the automation controller and the social network collectively serve as the intermediary between the peripheral device and the user.

The other user can be a trusted user. The other user can be a user of the social network. In some examples, the other user is an individual or entity (e.g., company) that the user has selected to be a friend of the user on the social network. The other user can be part of a user group of the user, such as a friend or acquaintance group. In some cases, the other user has a 1 degree (e.g., friend) or at most a 2 degree (e.g., friend of a friend) or 3 degree separation from the user.

Upon receiving the indication, the user or the other user can select a course of action, such as providing one or more instructions to effect a given action on the peripheral device (through the automation application). For example, the instructions can include turning off the peripheral device, or increasing the temperature of a home environment.

The at least one peripheral device can comprise a plurality of peripheral devices. In some cases, the plurality of peripheral devices comprises a sensor peripheral device (e.g., temperature sensor) and a non-sensor peripheral device (e.g., heater, cooler, washing machine, security system, or entertainment system).

The indication can be provided in the social network. For example, the indication can be provided on a UI of an electronic device of the user that accesses the automation application on the social network. The indication can be provided in a list or pop-up, for example. In some cases, the indication is provided on a newsfeed (or other data feed) of the social network, or a dedicated location in the social network. In some cases, the indication is provided in a pop-up in the social network, a drop-down in the social network, or an alert in the social network.

Methods of the present disclosure can be implemented using various systems provided herein. In an aspect of the present disclosure, a system for communicating with at least one peripheral device of a user comprises a port that is in communication with the peripheral device and a network communication module that is in communication with a social network that is hosted by a computer server. The social network can comprise an automation application that enables a user to (i) provide one or more instructions to control or regulate the peripheral device, or (ii) receive at least one indication as to a state of the peripheral device. The system further includes a computer processor that is operatively coupled to the port and the network communication module. The computer processor can be programmed to (i) receive the one or more instructions from the automation application of the social network through the network communication module, and/or (ii) receive information from the peripheral device through the port and direct the at least one indication to the social network through the network communication module.

Reference will now be made to the figures, wherein like numerals refer to like parts throughout. It will be appreciated that the figures and features therein are not necessarily drawn to scale.

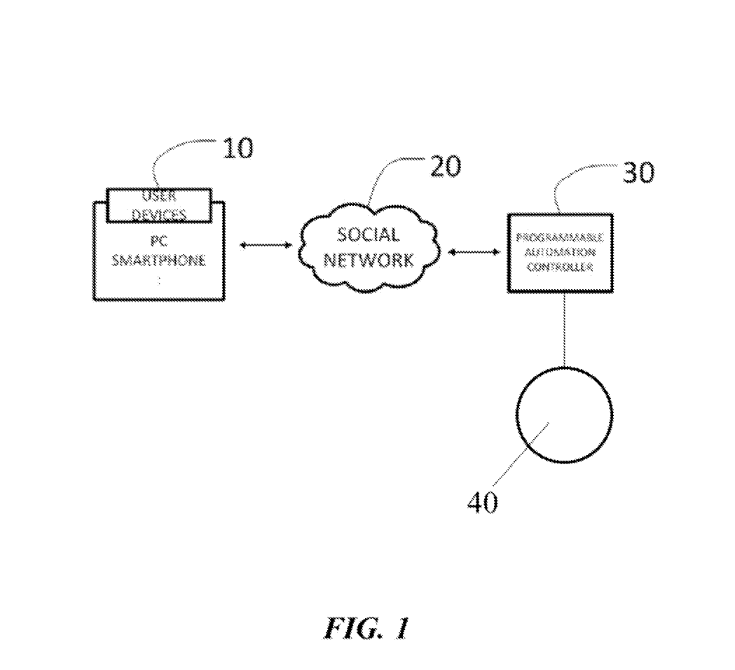

FIG. 1 schematically illustrates a programmable automation system that is controllable through a social network. The system comprises a user communication device 10 (e.g., computer, Smart phone, communicator, etc.), a social network 20 (e.g., Facebook®, Google+®, VK.COM, or LinkedIn®), a programmable automation controller (PAC) 30, and at least one peripheral (or executive) device 40. The at least one peripheral device 40 is in communication with the PAC 30. The social network 20 is in communication with the user communication device 10 and the PAC 30.

In the illustrated example of FIG. 1, the social network 20 is coupled to one PAC, but the social network 20 can be coupled to a plurality of PAC's. For instance, the social network 20 can be coupled to at least 1, 2, 3, 4, 5, 6, 7, 8, 9, 10, 20, 30, 40, 50, or 100 PAC's. At least a subset of the PAC's can be under the control of the same user. This can enable the user to control, monitor or communicate with multiple environments (e.g., homes or offices) using a single account on the social network 20.

The user communication device 10 can be any electronic device that is programmed or otherwise configured to bring a user in communication with the social network 20. Such communication can be wired or wireless communication. In some cases, the user communication device 10 is in remote communication with the social network 20. In some examples, the user communication device 10 a portable electronic device, such as a laptop personal computer (PC), Smart phone (e.g., Apple® iPhone or Android® enabled phone), slate or tablet PC (e.g., Apple® iPad or Samsung® Galaxy Tab), or telephone. The user communication device 10 can include various hardware and software components to permit the user communication device 10 to communication with the social network 20.

The social network 20 can be provided or hosted by one or more computer servers of a social network provider. The one or more computer servers can be in communication with one another in a distributed or decentralized fashion. The one or more computer servers can be in communication with the user communication device 10 and the PAC 30 through a computer network, such as an intranet or the Internet.

The PAC 30 can be situated at a location that is remote from the one or more computer servers hosting the social network 20. The PAC 30 can be situated at a location that is remote from the user communication device 10. In some examples, the PAC 30 is situated at a home or office of the user, or other structure or location selected by the user for accessing the at least one peripheral device 40. The PAC 30 can be in or on a housing, structure or other enclosure having the at least one peripheral device 40.

The peripheral device 40 can be any device that is controlled, regulated or otherwise accessed by the PAC 30. In an example, the peripheral device 40 is an appliance, such as a refrigerator, stove, microwave, dishwasher, laundry machine or dryer. In another example, the peripheral device 40 is an entertainment device, such as a gaming system (e.g., Sony® Playstation 4 or Microsoft® Xbox One), television, streaming device, or digital video recorder (DVR). In another example, the peripheral device 40 is a home environment system, such as a cooler and/or heater. In another example, the peripheral device 40 is a monitoring system, such as an alarm or camera. In another example, the peripheral device 40 is a health monitoring system, such as a heart rate monitor or blood pressure monitor. In another example, the peripheral device 40 is a sensor or a plurality of sensors, such as a heat sensor, toxic gas detector (e.g., carbon monoxide monitor), or fire detector.

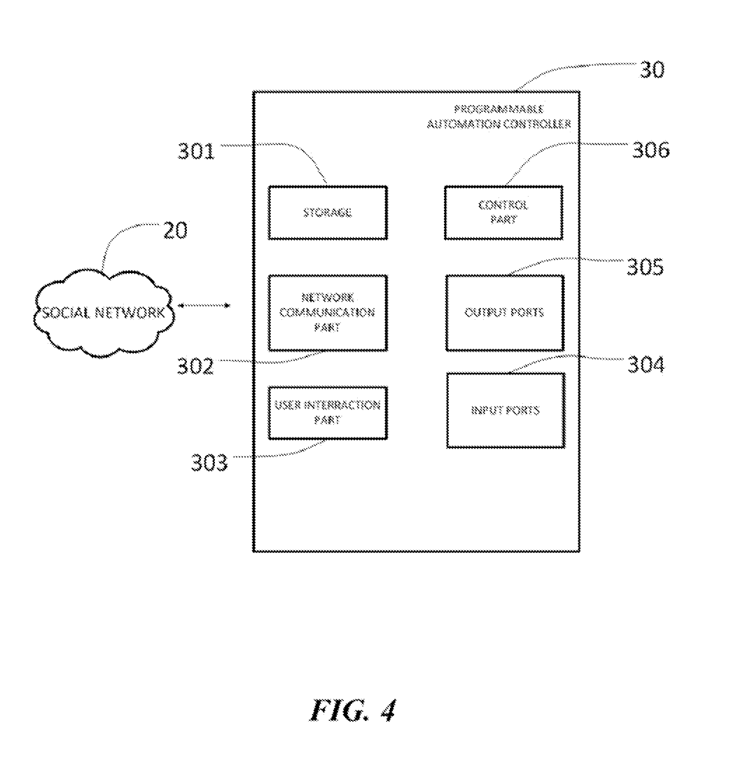

In some cases, the PAC 30 is an electronic hardware device. The PAC 30 can include various hardware (e.g., at least one computer processor and memory) and software to enable the PAC 30 to communication with the social network 20 and control, regulate or otherwise access the peripheral device 40. The PAC 30 can have the ability to connect to a social network 20. The PAC 30 can interface and communicate with all of the various systems and subsystems present within the automation environment, switch electrical power to a plurality of electrical devices connected to its output ports (e.g., output port 305, FIG. 4) (e.g., step motor, lamp, valve, electromechanical relay, heater, etc.), and process data from a plurality of subsystems and sensors connected to its input ports (e.g., input port 304, FIG. 4) (e.g., limit switch, temperature sensor, smoke detector, etc.). Decisions about how to switch electrical power to such devices can be determined by programs or other routines running on the PAC 30. The PAC 30 can store present and previous states of sensors, and process commands of the user through an interface within a social network account. The interface can be a user interface, such a web-based interface or a graphical user interface (GUI). The PAC 30 can also generate alerts according to specific predetermined conditions (e.g., fire detection, water leaks, etc.) determined by programs running on the PAC 30 and present states of its input 304 and output 305 ports. Such conditions can be determined by the user. As an alternative, or in addition to, the alert can be generated by an application on the social network 20. The alert can be displayed on the application or in the social network, such as, for example, on an alert window, a pop-up, a drop-down, a newsfeed, or a dedicated location in the social network.

The PAC 30 can manage and control various physical processes and systems by connecting devices (not shown) to its output ports 305 and processing feedback about the states of such devices from sensors (not shown) connected to its input ports 304. The states can include, for example, information as to one or more operating parameters of the devices, modes of operation of the devices or information received by the devices as to an environment that is being monitored by the devices.

In some embodiments, the social network 20 enables the user to communication with the PAC 30 and can be the main component of the infrastructure of the automation complex (the sum of a PAC 30, sensors and devices connected to its ports (304, 305) and peripheral device under its supervision and control). The social network can be a communications environment between a user and the PAC 30, and provide storage for logs (e.g., sensor states, peripheral device states, states of PAC 30). The social network 20 can have electronic storage that contains software drivers for devices connected to ports of PAC 30, and electronic storage for computer programs that can be executed on the PAC 30. The ports can be in communication with the peripheral device. The social network 20 can provide the infrastructure for delivering alerts from a PAC 30 to a user (or to a trusted person, service, etc.), has an installation utility for helping to deploy an automation system, etc.

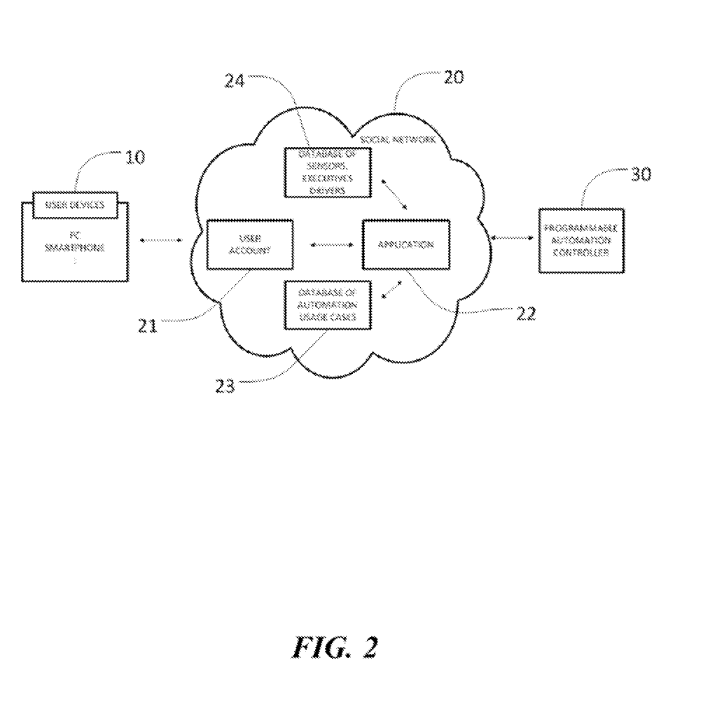

FIG. 2 schematically illustrates example components of an automation system based on the social network 20. The social network 20 includes at least one user account 21 to provide the user with the ability to login into the social network 20, an application 22 to provide the user with necessary functionality to control and maintain the automation environment, a database 23 of automation usage cases of the automation complex, and a driver database 24. The driver database 24 includes drivers to enable the PAC to communicate with various peripheral devices, such as sensors and appliances.

Application 22 can be a program compatible with an application programming interface (API) of a social network, such as the social network 20. Application 22 can be stored in and execute within a social network's infrastructure. Application 22 can provide the user with all of the functionality of a PAC 30, from communication to automatic installation assistance, from within the user's social network account.

The driver database 24 can contain software drivers for devices and sensors connected to ports of the PAC 30 and executive devices under its control. It engages in the process of the automation complex upgrade, installation and expansion. Drivers are compatible with and execute on PAC 30. Developers and hardware manufacturers (of sensors and executive devices connected to PAC 30 ports 304, 305) can have the ability to add their drivers into the database 24. For example, the social network 20 can have an upload feature that provides developers and other users the ability to upload drivers into the database 24. In some cases, the application 22 reviews the drivers for compatibility with peripheral devices.

The database 23 can include profiles of cases of usage of a PAC 30. The database 23 can engage in the process of installation, upgrade and expansion of an automation complex based on a PAC 30 and the sensors and executive devices connected to ports (e.g., 304 and 305) of the PAC 30. Cases of usage can be sets of algorithms, programs, profiles, and settings of a PAC 30 embodied in program form (e.g., software), which can be designed to perform a specific process, or a group or plurality of processes. Cases of usage database 23 can be used to tune the PAC 30 and the sensors and devices connected to its ports and the executive devices under its control, to manage some useful processes. Examples of cases of usage contained in database 24 include fire monitoring, water leak monitoring, climate control, watering the lawn, security, security monitoring, and health, fitness and/or wellness monitoring. Cases of usage of database 23 can be records containing specific fields for tuning a PAC 30 to manage specific processes and aliases. Such specific processes and aliases can be expressed in a form that is readily understandable by a user (e.g., graphical or textual form). Aliases can be used for user understandability and proper selection of usage cases. A group of usage cases can be executed on a PAC 30 simultaneously. The number of cases of usage (records from database 23) executed on the PAC 30 simultaneously can depend on user needs, and on the types of devices (e.g., appliances or sensors) connected to a PAC 30 and/or the executive devices under its control. Application 22 can suggest to a user a recommended selection from database 23 and offer cases of usage according to the available devices connected to the PAC 30. Application 22 can have the ability to suggest to the user to connect the appropriate devices to the PAC 30 to execute the actions desirable by the user, according to a case of usage from database 23. User and third party developers can have the ability to add and edit records of database 23.

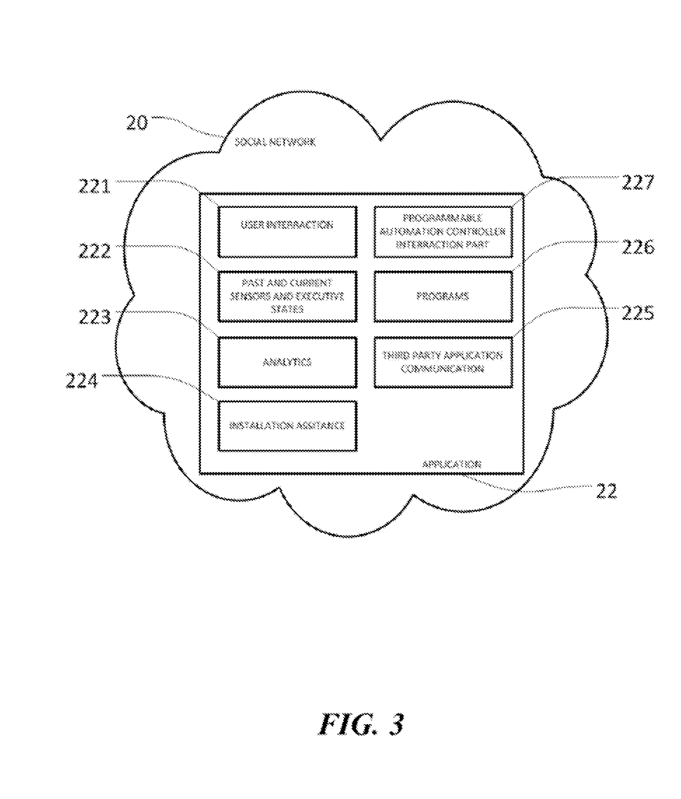

FIG. 3 schematically illustrates an example structure of the social network application 22. Application 22 can be a program that executes on the social network 20. The application 22 can be an automation application. The application can be executed by a computer server that provides (or hosts) the social network 20. A user can interact with the social network 20 via the user's social network account 21. Non-limiting functions of application 22 are to communicate with a PAC 30 (e.g., get information from it about its current state(s) and devices and sensors connected to its ports (304, 305), and executive devices under its control, to program it, etc.), to store states of a PAC 30, to assist a user to install and upgrade an automation system based on PAC 30, for example.

The application 22 further comprises a user interaction module 221, which can be a user interface (UI). In some examples, the UI is a web-based interfaced (e.g., accessible through the Internet or an intranet) or a GUI. The UI can provide the user with graphical and/or textual information to enable the user to interact with the application 22 and the social network 20. The application 22 further includes a database module 222 that stores current and previous states of the PAC 30, as well as peripheral devices connected to the PAC 30 and under the control or supervision of the PAC 30. An analytics module 223 of the application 22 is represented by a group of algorithms that process data from the database module 222, user activity (not shown) and any changes of states of components of the social network application 22. The analytics module 223 can represent data from the database module 222 in a user accessible form, such as in graphical and/or textual form (e.g., tables, graphs, etc.).

In an example, an electrical power consumption sensor is connected to PAC 30 input port 304. Consumption parameters from this sensor are stored in the database module 222. The user wishes to see how much power was consumed in the previous month. An algorithm can represent this information in a monthly consumption graph, which shows power consumption (vertical axis) as a function of time (horizontal axis). An analysis routine of the analytics module 223 can generate alerts for the user (or a third party, such as a trusted third party) depending on the current state of the PAC 30 and peripheral devices coupled to the PAC 30, and provide suggested cases of usage selected from database 23. For example, the functionality of the PAC 30 determined by the case of usage “fire monitor” processes and sends data from fire sensor(s) connected to port 304 of the PAC 30. If an actionable event is detected, an alert is then sent to a user account 21 or an account of a third party user, such as a trusted third party (e.g., another person, company, etc.). An alert could also be sent to a third party via third party application communication module 225 to any other service outside the social network 20. The third party application communication module 225 can include an interface that brings the application 22 in communication with a third party application, such as an electronic messaging application (e.g., email, text messaging or instant messaging), another social network account, or other third party servers' applications

The application 22 can further include an installation assistant 224, which can be a routine that provides a user with the ability to program the functionality of the PAC 30 and assist in its installation and tuning procedure in automatic and partially automatic manners. Depending on the devices coupled to (e.g., connected to) the PAC 30, the assistant 224 can download to the PAC 30 the appropriate drivers to set up communication between the PAC 30 and the devices connected to the PAC 30. The assistant 224 can offer a user the appropriate case of usage from the database 23, which usage cases can vary depending on the devices coupled to the PAC 30. If a user wants to program the functionality of the PAC 30 differently than the options offered by assistant 224, then the assistant 224 can provide the user the opportunity to connect appropriate additional devices to the PAC 30.

In some cases, the assistant 224 can include a questionnaire (e.g., guided questionnaire) that enables the user to program the functionality of the PAC 30. As an alternative, or in addition to, the assistant 224 can include one or more predefined configurations that are each tailored to a given functionality of the PAC 30.

The application 22 can further include a third party communication channel 225 that can enable the application 22 to communicate with external subroutines and services inside or outside the social network 20. For example, some companies offer the service of monitoring fire detection alarms and they take specific actions when they receive an alarm signal. In this case, the user can route such alerts to any company of their choice through the appropriate social network service of the company, as described herein.

The application 22 can further include programs 226 that can be a set of software routines that determine the functionality (case of usage) of the PAC 30. The programs 226 can be created by a user and/or a third parties. A library of usages cases (programs 226) can be stored in usage cases database 23 of the social network 20. Programs 226 can expand the functionality of the automation system by allowing logical determinations to be made based on sensor and/or device inputs, and then issuing commands to peripheral devices operatively coupled to the PAC 30 based on the logical determinations. They could be uploaded to, or downloaded from, the PAC 30 through a communication channel of a programmable automation controller interaction module 227 of the application 22. The programmable automation controller interaction module 227 can include a set of software algorithms that provide the application 22 and its components the ability to communicate with the PAC 30 remotely.

In some cases, the application 22 and the social network 20 can be accessed by an electronic device of a user, such as a mobile or portable electronic device (e.g., Smart phone, tablet PC, or laptop PC). The electronic device can include a UI that permits the user to access the social network 20 and the application 22. The application 22 can be among one or more other applications on the social network 20, which can include gaming applications (or “apps”).

FIG. 4 is a block scheme of a PAC 30 that is controllable through a social network 20. The PAC 30 can access (e.g., control, monitor or otherwise communicate with) one or more peripheral devices connected to its output ports 305. The PAC 30 can access a given peripheral device by switching electrical power to the given peripheral device. In some cases, the PAC 30 can collect data from a plurality of sensors (not shown) connected to its input ports 304. Power switching to peripheral devices can be determined by programs stored in non-volatile memory 301 of the PAC 30.

The PAC 30 can include various hardware and software components. In the illustrated example of FIG. 4, the PAC 30 includes computer storage 301, network communication module 302, user interaction module 303, at least one input port 304, at least one output port 305, and a control module 306. Programs can be downloaded into the storage 301 through the application 22 on the social network 20, or programmed by a user via an interface module 303 of the PAC 30.

The storage 301 can be memory, such as non-volatile memory. The storage 301 can store programs that determine the functionality of the PAC 30, provide a buffer to store states of the PAC 30, and can store the states of sensors and executive devices connected to the PAC 30.

The network communication module 302 can provide the PAC 30 the ability to communicate with the social network application 20 via a wired or wireless communication protocol (e.g., Ethernet, Bluetooth, Wi-Fi, Long Term Evolution, 2G, 3G, etc.).

The user interaction module 303 can include an electronic display and a wireless interface (e.g., Bluetooth or Wi-Fi) to provide the user with the ability to program functionality of the PAC 30. The functionality of the PAC 30 can be programmed using the application 22 of the social network. The electronic display can be a touch screen display, such as a capacitive or resistive touch screen.

The input port 304 can include one or more wired and/or wireless communication circuits (Wi-Fi, ZigBee, Bluetooth, controller area network, etc.) that can provide the PAC 30 with the ability to set-up connections with a plurality of peripheral devices, such as sensors (e.g., temperature, pressure, humidity, gas, fire, presence, etc.).

The output port 305 can include one or more relays (e.g., electromechanical, solid state, etc.) that enable the PAC 30 to switch electrical power to a plurality of peripheral devices, such as executive devices (e.g., step motors, lamps, valves, door locks, etc.), in order to activate or deactivate the devices. The executive devices can be part of larger devices or systems, such as appliances or entertainment equipment.

Examples of peripheral devices include thermostats, appliances (e.g., oven, dishwasher, microwave, refrigerator), heaters, coolers, televisions, radios, locks (e.g., door locks), lights, and cameras. Devices, systems and methods of the present disclosure can be used to control or regulate such peripheral devices, such as monitor a status of such peripheral devices, receive information from such peripheral devices, or regulate power to such peripheral devices (e.g., turn a peripheral device on or off).

The control module 306 can include one or more computer processors. In some examples, the control module 306 includes a microcomputer electronic device. The control module 306 can execute programs stored in the storage 301 to, for example, access a peripheral device.

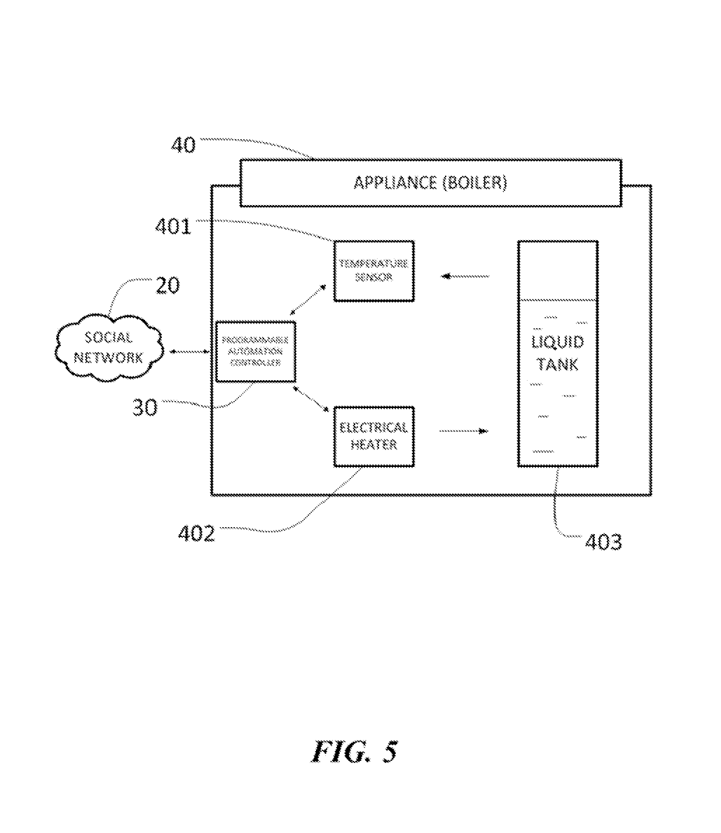

In some cases, the PAC 30 may be an integral part (in role of automation controller) of some appliance to manage some useful physical process. As an example of such an appliance is an automated water boiler illustrated in FIG. 5. The scope of usage of the PAC 30 as an integral controller part of the appliance is not limited by the sample shown in FIG. 5. The PAC 30 can be, for example, an integral part of a coffee machine, a heater and/or cooler, gas or electrical stove, or a laundry machine. Various appliances can be constructed (with PAC 30 as the integral controller) to be controllable through a social network.

The PAC 30 can be a main automation controller of the peripheral device 40, switching power to the peripheral device 40 or otherwise accessing the device 40 to direct instructions to or receive information from the device 40. Non-sensor peripheral devices can be operatively coupled to the output port(s) 305 of the PAC 30. Sensing peripheral devices (or sensors) 401 can be operatively coupled to the input port(s) of the PAC 30. Sensors 401 can act as transducers for measuring parameters of controllable physical processes (water boiling in the context of FIG. 5). The PAC 30 can execute the appropriate case of usage (program) to manage water boiling. Usage cases can be downloaded from the database 23 of the social network 20 during manufacture of the peripheral device 40 or integration of the device 40 into the automation environment comprising the PAC 30.

The system of FIG. 5 can include other peripheral devices, such as a heater 402. The heater 402 is a device that provides heat radiatively, using combustion, or upon the flow of electrical current, for example. In the illustrated example, the heater 402 is an electric heater. The heater 402 is in thermal communication with a liquid tank 403. The heater 402 can be connected to the output port 305 of the PAC 30. The PAC 30, controlled through social network, can be used to monitor and control the device 40, including various components of the device 40, such as the heater 402.

In some examples, the temperature sensor 401 is a transducer (for example, a thermocouple) connected to the input port 304 of the PAC 30. The sensor 401 can provide feedback as to the current temperature of the liquid inside of the liquid tank 403.

Systems of the present disclosure can provide various advantages. For instance, systems of the present disclosure can provide a unified method of installation, upgrade and expansion of an automation complex independent of its case of usage, which can be achieved by using a social network for the installation process, a help source (e.g., assistance from application 22, or from a person or commercial service), a storage base for software drivers of sensors connected to a PAC 30 and for executive devices under its supervision and control, a program CAD, and a storage base for a variety of cases of usage offered to the user for installation to the PAC 30.

As another example, systems of the present disclosure can provide a unified method of interaction independent of case of usage of a deployed automation complex and the physical distance to the user. A social network can act as a single user interface to control, monitor, and change the functionality of the automation complex.

Systems of the present disclosure can provide user alerts in a unified manner, and can enable a user to delegate alerts to one or more third parties. Wherever a user exists (e.g., far away from an automation complex or close to the automation complex), the connection to the social network 20 can enable the user to receive alerts from the PAC 30. The alerts can be related to peripheral device operatively coupled to the PAC 30. Additionally, systems of the present disclosure can provide a unified approach to program functionality, retarget and tune an automation complex, independent of case of usage of automation.

### Control Systems

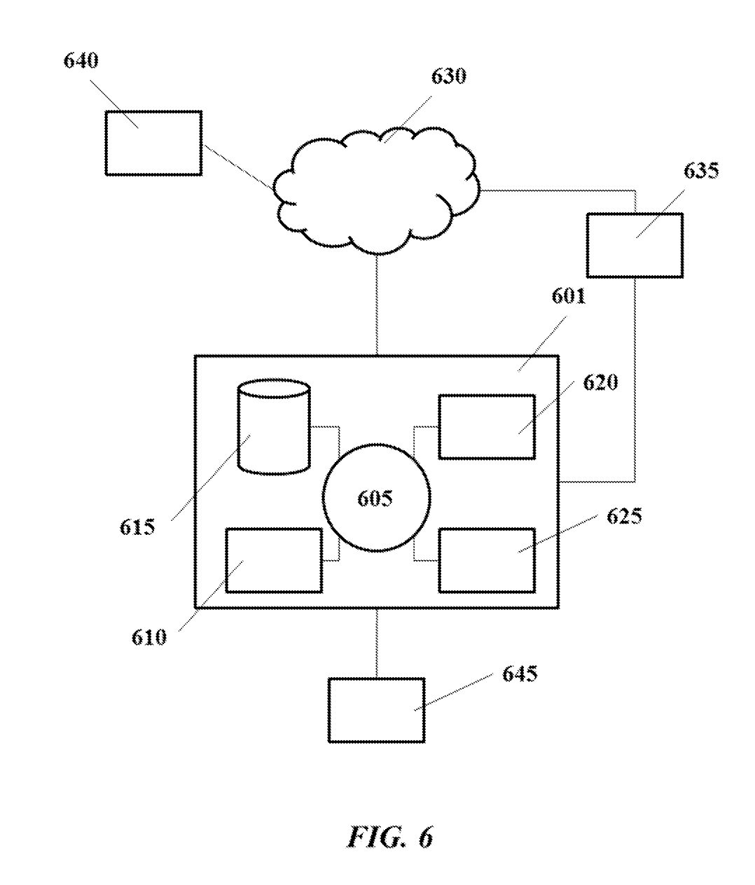

The present disclosure provides computer control systems that are programmed to implement methods of the disclosure. FIG. 6 shows a computer system 601 that is programmed or otherwise configured to enable a user to access (e.g., control, receive information from or communicate with) a peripheral device using a social network. The computer system 601 can be part of a programmable automation controller, such as the PAC 30 described herein.

The computer system 601 includes a central processing unit (CPU, also “processor” and “computer processor” herein) 605, which can be a single core or multi core processor, or a plurality of processors for parallel processing. The computer system 601 also includes memory or memory location 610 (e.g., random-access memory, read-only memory, flash memory), electronic storage unit 615 (e.g., hard disk), communication interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communication bus (solid lines), such as a motherboard. The storage unit 615 can be a data storage unit (or data repository) for storing data. The computer system 601 can be operatively coupled to a computer network (“network”) 630 with the aid of the communication interface 620. The network 630 can be the Internet, an internet and/or extranet, or an intranet and/or extranet that is in communication with the Internet. The network 630 in some cases is a telecommunication and/or data network. The network 630 can include one or more computer servers, which can enable distributed computing, such as cloud computing. The network 630, in some cases with the aid of the computer system 601, can implement a peer-to-peer network, which may enable devices coupled to the computer system 601 to behave as a client or a server.

The CPU 605 can execute a sequence of machine-readable instructions, which can be embodied in a program or software. The instructions may be stored in a memory location, such as the memory 610. Examples of operations performed by the CPU 605 can include fetch, decode, execute, and writeback.

The storage unit 615 can store files, such as drivers, libraries and saved programs. The storage unit 615 can store programs generated by users and recorded sessions, as well as output(s) associated with the programs. The storage unit 615 can store user data, e.g., user preferences and user programs. The computer system 601 in some cases can include one or more additional data storage units that are external to the computer system 601, such as located on a remote server that is in communication with the computer system 601 through an intranet or the Internet.

The computer system 601 can communicate with one or more remote computer systems, or vice versa, through the network 630. For instance, the computer system 601 can communicate with a remote computer system of a user (e.g., social network user). Examples of remote computer systems 635 include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. In the illustrated example, the computer system 601 is in communication with a remote computer system 635 of a user through the network 601 or through direct connection (e.g., wired or wireless) to the remote computer system 635. The user can access or otherwise communicate with the computer system 601 using the remote computer system 635.

The computer system 601 can be in communication with another remote computer server 640 that is programmed or otherwise configured to host a social network. The computer system 601 can also be in communication (e.g., by wired or wireless connectivity) with at least one peripheral device 645 of the user. The computer system 601 and peripheral device 645 can be located in a home, office or other setting or environment of or associated with the user. The computer server 601 can be external to the home, office or other setting or environment of or associated with the user. Using the remote computer system 635, the user can access the social network at the remote computer server 640 in order to regulate, control or access the peripheral device 645 using the computer system 601.

Methods as described herein can be implemented by way of machine (e.g., computer processor) executable code stored on an electronic storage location of the computer system 601, such as, for example, on the memory 610 or electronic storage unit 615. The machine executable or machine readable code can be provided in the form of software. During use, the code can be executed by the processor 605. In some cases, the code can be retrieved from the storage unit 615 and stored on the memory 610 for ready access by the processor 605. In some situations, the electronic storage unit 615 can be precluded, and machine-executable instructions are stored on memory 610.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communication. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 601 can include or be in communication with an electronic display that comprises a user interface (UI). Examples of UP s include, without limitation, a graphical user interface (GUI) and web-based user interface.

### EXAMPLE 1

A PAC 30 is used to manage one or more processes. The functionality of the PAC 30 can be determined by sensors (not shown) and executive devices (not shown) connected to it and program(s) executed on it. Programs can be stored into non-volatile memory 301 (FIG. 4).

For clarification, here is a specific example of an automation process that a PAC 30 is installing and managing. A user wants control their home lighting, ventilation, and security. Security is represented by a number of ZigBee motion sensors. First, a user connects the ventilation system and lighting equipment to output ports 305 of PAC 30. After the user enters their social network account 21, parameters of PAC 30 are configured by the user via the user interface 303. This step activates the social network application 22 and connects it to the user's social network account 21. Application 22 analyzes connected sensors (in this example, ZigBee motion sensors) and asks what types of executive devices are connected. Then application 22 offers to user specific cases of usage from the database 23 that are appropriate to the sensors and executive devices connected to the PAC 30. The user selects for example these cases: “Temperature control”, “Security”. After the usage cases selected in the application 22 download appropriate programs into the PAC 30 to manage the sensors and executive devices, the appropriate control and monitoring panels in the form of a GUI then become available to the user in their social network account 21. Installation is complete.

If a user feels some discomfort with the installation process, then they can share the application with a third party, such as a skilled person, or a technical support service, that is present in the social network, for remote installation assistance.

### EXAMPLE 2

The user from Example 1 wishes to expand the functionality of their home automation system by adding the function of electrical power consumption control. They select in the application 22 the appropriate case of usage (e.g., its name is “Electricity consumption control”). The application 22 analyzes the presence of the appropriate sensor(s) connected to the PAC 30. In the case that the system senses an absence of the appropriate sensors, the application 22 suggests the appropriate sensor(s) should be connected, and it then lists those that are available on market. After the user connects the appropriate sensors, the application 22 activates the appropriate GUI panel for control and monitoring through the social network account 21 of the user. If the database 23 doesn't contain any appropriate cases of usage for programming specific functionality of the PAC 30, the user can create a suitable program through the application 22, or request assistance from a third party person or service present in the social network. This specific case of usage (in the form of a program) could be shared with another user through the database 23.

In some situations, when a PAC 30 and application 22 are properly installed and activated, the PAC 30 executes programs in accordance with the user-selected cases of usage from the database 23. Current and past states of automation (PAC 30, its connected sensors, and executive devices, etc.) are logged by application 22. The user can control and monitor states of the PAC 30 through the social network application 22, remote or close distance.

In some embodiments, alerts are generated in the form of logs by the application 22. Alerts are specific alarm messages based on cases of usage. For example, in the usage case described above, such messages could be alerts from motion detection sensors. Alerts are critical messages about states of processes manageable by the PAC 30. These messages could be marked as critical by the case of usage or by the user. These alerts need the attention of a human as fast as possible. Samples of these alerts also could be detection of fire, smoke, heat, gasses, etc. Nowadays, the owner of a home where automated processes are managed sometimes cannot react immediately to these alerts. They could be out of the area, away from the internet, etc. Our automation system gives the ability to determine alerts by type and delegate management of these alerts to third parties. A user can delegate responsibility for a group of alerts to person or a commercial service present in the social network, or even a third party not present in the social network (application 22 has a specific component 225 to connect to different types of communication interfaces (e.g., instant message, text message, electronic mail, telephone call, etc.)). The user can select any trusted person or commercial service via the application 22 to have continuous non-stop control of critical parameters of the system. There is no need to buy and install extra software or hardware for this purpose. The alert solution is based on the IT infrastructure of the social network and its components.

In some embodiments, the PAC 30 is a standalone automation device capable of interacting with the social network application 22. The sum of such interaction brings to the user a unified method of installation, interaction, monitoring, control, expansion, upgrading, alerting and delegation of alerts responsibility to third parties, independent of the distance between the user and the PAC 30 and type of manageable process by the PAC 30. However, the PAC 30 could be used as a module of some electrical appliance in order to make this appliance controllable through a social network application 22. This is illustrated in FIG. 5. For example, to create a boiler 40 controllable through the application 22, a manufacturer can use a PAC 30 as an automation controller inside the boiler. Usually, the boiler consists of a liquid-filled tank 403, a heater 402 to boil this liquid, a temperature sensor(s) 401 to provide feedback on the current temperature of the liquid, a control panel on which a user specifies the desired temperature, and some automation that controls the current temperature and supplies heat by electrical power. By using the PAC 30 for the automation of something such as a boiler, the manufacturer can create an appliance controllable through the social network application 22. This gives the ability for the user to get a unified control panel for the boiler 40 in their social network account 21 and application 22.

Various embodiments of PAC 30 can be used as an integrated part of an electrical appliance to give it the ability to be controllable through the user's social network account 21. All appliances where there are electrically powered executive devices (e.g., valves, motors, heaters, compressors, etc.), and sensors as a feedback mechanism to control those devices, can include a PAC 30 as its main automation controller.

### EXAMPLE 3

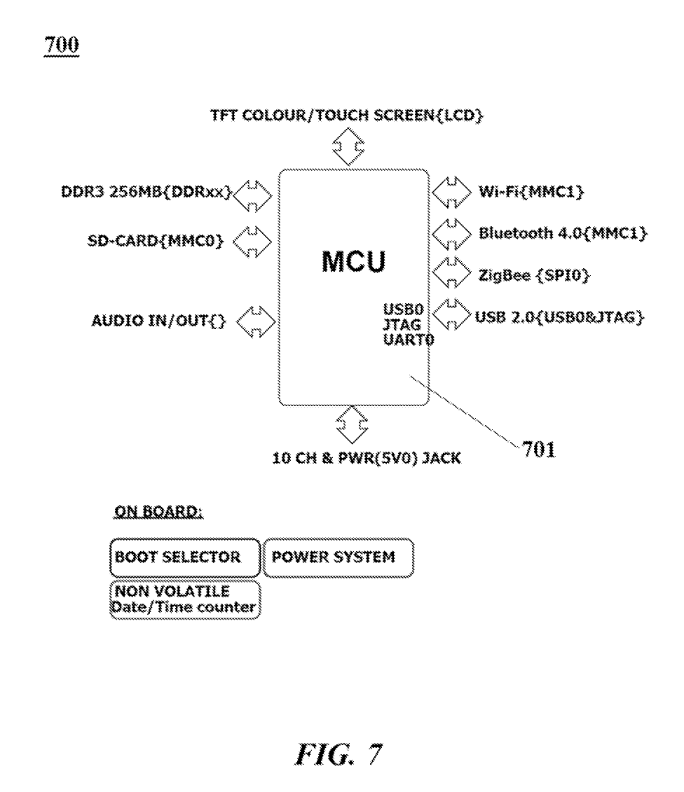

FIG. 7 schematically illustrates a circuit diagram of an example programmable automation controller. The PAC 700 includes a microcontroller (MCU) 701 and can be operatively coupled to various devices, such as a touch screen. The PAC 700 can have various communications interfaces, such as Wi-Fi, Bluetooth, ZigBee and universal serial bus (USB).

Devices, systems and methods of the present disclosure may be combined with or modified by other devices, systems or methods, such as those described in U.S. Patent Publication No. 2012/0123561 (“CUSTOMIZED CONTROL SYSTEM FOR ELECTRICAL APPLIANCES USING REMOTE DEVICE”), which is entirely incorporated herein by reference for all purposes.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for accessing at least one peripheral device of a user, comprising:
(a) using a user interface on an electronic device of a user, accessing an automation application in a social network hosted by at least one computer server, wherein said computer server is in communication with an automation controller that is operatively coupled to at least one peripheral device of said user, and wherein said peripheral device is accessible by said automation application through said automation controller;
(b) receiving, by said automation application accessed through said user interface, at least one user instruction from said user to access said peripheral device;
(c) using said computer server, directing said automation controller to access said peripheral device based on said user instruction; and
(d) accessing said peripheral device based on said user instruction.

2. The method of claim 1, wherein said instruction is to receive information from said peripheral device, and wherein said information is received from said peripheral device and presented to said user in said automation application.

3. The method of claim 2, wherein said information is of or related to a state of said peripheral device.

4. The method of claim 1, wherein said instruction is to control or monitor said peripheral device.

5. The method of claim 1, wherein said at least one peripheral device comprises a plurality of peripheral devices.

6. The method of claim 5, wherein at least a subset of said plurality of peripheral devices includes different devices.

7. The method of claim 1, further comprising, prior to (a), bringing said automation controller in communication with said computer server.

8. The method of claim 7, further comprising providing, from said automation application, one or more drivers to enable said automation application to communicate with said peripheral device.

9. The method of claim 1, wherein said peripheral device is an appliance, a monitoring system, a sensor, or an entertainment system.

10. The method of claim 1, further comprising, subsequent to (d), directing an alert to said user using said social network.

11. The method of claim 1, further comprising, subsequent to (d), directing an alert to another user selected by said user.

12. A method for communicating with at least one peripheral device of a user, comprising:
(a) providing a computer server that is in communication with an automation controller that is operatively coupled to at least one peripheral device of said user, wherein said computer server hosts a social network that comprises an automation application that is programmed to permit said user to access said peripheral device;
(b) receiving, at said computer server through said automation controller, information from said peripheral device that is of or related to a state of said peripheral device or an environment in proximity to said peripheral device; and
(c) based on said information received at said computer server, providing said user or another user selected by said user an indication as to said state, which indication is provided to said user or said another user through said automation application on said social network.

13. The method of claim 12, wherein said access comprises receiving information from or providing instructions to said peripheral device.

14. The method of claim 12, wherein said at least one peripheral device comprises a plurality of peripheral devices.

15. The method of claim 14, wherein said plurality of peripheral devices comprises a sensor and a non-sensor peripheral device.

16. The method of claim 12, further comprising, prior to (a), bringing said automation controller in communication with said computer server.

17. The method of claim 16, further comprising providing, from said automation application, one or more drivers to enable said automation application to communicate with said peripheral device.

18. The method of claim 12, wherein said indication is provided in said social network.

19. The method of claim 18, wherein said indication is provided on a newsfeed of said social network.

20. The method of claim 12, wherein said indication is provided in a third party application that is external to said social network.

21. The method of claim 12, wherein said peripheral device is an appliance, a monitoring system, a sensor, or an entertainment system.

22. The method of claim 12, wherein said indication is an alert.

23. A system for communicating with at least one peripheral device of a user, comprising:
(a) a port that is in communication with said peripheral device;
(b) a network communication module that is in communication with a social network that is hosted by a computer server, wherein said social network comprises an automation application that enables a user to (i) provide one or more instructions to control or regulate said peripheral device, or (ii) receive at least one indication as to a state of said peripheral device; and
(c) a computer processor that is operatively coupled to said port and said network communication module, wherein said computer processor is programmed to (i) receive said one or more instructions from said automation application of said social network through said network communication module, or (ii) receive information from said peripheral device through said port and direct said at least one indication to said social network through said network communication module.

24. The system of claim 23, wherein said access comprises receiving information from or providing instructions to said peripheral device.

25. The system of claim 23, wherein said at least one peripheral device comprises a plurality of peripheral devices.

26. The system of claim 25, wherein at least a subset of said plurality of peripheral devices includes different devices.

27. The system of claim 23, wherein said peripheral device is an appliance, a monitoring system, a sensor, or an entertainment system.

28. The system of claim 23, wherein said indication is an alert.

29. The system of claim 23, wherein said one or more instructions are provided by said user through said automation application.

30. A computer readable medium comprising machine-executable code that, upon execution by one or more computer processors implements a method for communicating with at least one peripheral device of a user, the method comprising:
(a) providing a computer server that is in communication with an automation controller that is operatively coupled to at least one peripheral device of said user, wherein said computer server hosts a social network that comprises an automation application that is programmed to permit said user to access said peripheral device;
(b) receiving, at said computer server through said automation controller, information from said peripheral device that is of or related to a state of said peripheral device; and
(c) based on said information received computer server, providing said user or another user selected by said user an indication as to said state of said peripheral device, which indication is provided to said user or said another user through said automation application on said social network.
